(19) United States
(12) Patent Application Publication
(10) Pub. No.: US 2013/0280003 A1
(43) Pub. Date: Oct. 24, 2013

(54) VEHICLE CHOCK ASSEMBLY AND METHOD

(71) Applicant: David A. Wessel, Carthage, IL (US)

(72) Inventor: David A. Wessel, Carthage, IL (US)

(21) Appl. No.: 13/449,652

(22) Filed: Apr. 18, 2012

(51) Int. Cl. B60T 3/00; B60P 3/077

(52) U.S. Cl. 410/30; 188/32

(57) ABSTRACT

A vehicle chock assembly is capable of spacing a vehicle from a surface having a height. The chock assembly is well-suited for use in spacing a vehicle being transported in a pick-up truck from the forward end wall of the truck bed and/or the rear wall of the truck cab. The chock assembly includes a first chock and a second chock supported relative to one another in an adjustable manner by a connecting rod or other connecting structure. A method of using the chock assembly to space a vehicle from a surface is also disclosed.

### BACKGROUND OF THE DISCLOSURE

1. Field of the Invention

The present invention relates generally to an apparatus or method for transporting or storing a vehicle. In particular, the present invention relates to an apparatus or method of spacing a vehicle from a surface having a height.

2. Description of the Related Art

Vehicle chocks or chocking systems exist to contact a wheel of a vehicle to prevent rotation of the wheel and hold the vehicle in a stationary manner. However, a need exists for an improved chocking system that is relatively lightweight, relatively inexpensive and is easily adjustable to work for a variety of different applications. These needs are not satisfied by the currently available systems.

### SUMMARY OF THE INVENTION

Preferred embodiments provide a chock assembly, system or method that addresses some or all of the insufficiencies of the prior art designs. In particular, certain preferred embodiments of the present chock assemblies, systems or methods provide a relatively lightweight, inexpensive and/or easily adjustable solution for spacing a vehicle from a surface having a height. In one arrangement, the chock assembly is well-suited for use in spacing a transported vehicle from the forward wall of a pick-up truck bed and/or a rear wall of the truck cab. The chock assembly can have a first chock and a second chock that are interconnected with one another to be adjustable in overall width to fit the width of the truck bed, the distance between the transported vehicle's tires, or preferably both.

An embodiment involves a vehicle chock assembly for spacing a vehicle from a surface having a height and positioned forward of the vehicle. The chock assembly has a first chock having a bottom surface, a rearward surface, a forward surface and two opposing side surfaces. The bottom surface has a forward edge and a rearward edge. The rearward surface has a bottom edge and a top edge. The rearward surface extends upward from the rearward edge of the bottom surface and is oriented substantially at a right angle relative to the bottom surface. The forward surface has a bottom edge and a top edge. The forward surface extends upward from the forward edge of the bottom surface. A passage extends from one of the side surfaces toward the other side surface. A second chock has a bottom surface, a rearward surface, a forward surface and two opposing side surfaces. The bottom surface has a forward edge and a rearward edge. The rearward surface has a bottom edge and a top edge. The rearward surface extends upward from the rearward edge of the bottom surface and is oriented substantially at a right angle relative to the bottom surface. The forward surface has a bottom edge and a top edge. The forward surface extends upward from the forward edge of the bottom surface. A passage extends from one of the side surfaces toward the other side surface. A connecting rod connects the first chock and the second chock in a spaced relationship. The connecting rod has a first linear end and a second linear end. The first linear end is received within the passage of the first chock and the second linear end is received within the passage of the second chock.

An embodiment involves a combination, which includes a vehicle having a pair of wheels spaced apart from one another along an axis of rotation, a surface from which the vehicle is spaced, the surface defining a height, and a chock assembly. The chock assembly includes a first chock and a second chock. The first chock has a bottom surface, a rearward surface, a forward surface and two opposing side surfaces. The bottom surface has a forward edge and a rearward edge. The rearward surface has a bottom edge and a top edge. The rearward surface extends upward from the rearward edge of the bottom surface. The forward surface has a bottom edge and a top edge. The forward surface extends upward from the forward edge of the bottom surface. A passage extends from one of the side surfaces toward the other side surface. A second chock has a bottom surface, a rearward surface, a forward surface and two opposing side surfaces. The bottom surface has a forward edge and a rearward edge. The rearward surface has a bottom edge and a top edge. The rearward surface extends upward from the rearward edge of the bottom surface. The forward surface has a bottom edge and a top edge. The forward surface extends upward from the forward edge of the bottom surface. A passage extends from one of the side surfaces toward the other side surface. A connecting rod connects the first chock and the second chock in a spaced relationship. The connecting rod has a first linear end and a second linear end. The first linear end is received within the passage of the first chock and the second linear end is received within the passage of the second chock. The chock assembly is positioned between the vehicle and the surface such that at least portions of the rearward surfaces of the first and second chocks contact the surface and one of the pair of wheels contacts the forward surface of the first chock and the other of the pair of wheels contacts the forward surface of the second chock.

An embodiment involves a method of spacing a vehicle from a surface defining a height. The method includes positioning a chock assembly between the vehicle and the surface. A position of one or both of a first chock and a second chock of the chock assembly is adjusted relative to a connecting rod that extends in between and interconnects the first chock and the second chock such that the first chock is aligned with a first wheel of the vehicle and the second chock is aligned with a second wheel of the vehicle. The vehicle is secured relative to the surface such that the first chock and the second chock contact the surface, and the first wheel contacts the first chock and the second wheel contacts the second chock.

### BRIEF DESCRIPTION OF THE DRAWINGS

These and other features, aspects, and advantages of the present invention are described herein with reference to drawings of preferred embodiments, which are intended to illustrate, but not to limit, the present invention. The drawings contain five (5) figures.

FIG. 1 is a perspective view of a vehicle chock assembly having certain features, aspects and advantages of the invention.

FIG. 2 is an elevational view of the vehicle chock assembly of FIG. 1 used to space a vehicle, such as an all-terrain vehicle, from a surface, such as the forward wall of a truck bed.

FIG. 3 is a side view of an alternative shape of a chock in which the forward surface is rounded.

FIG. 4 is a side view of another alternative shape of a chock, which is triangular.

FIG. 5 is a side view of yet another alternative shape of a chock, which is circular.

### DETAILED DESCRIPTION OF THE PREFERRED EMBODIMENTS

In the following detailed description, terms of orientation or relative terms such as “first”, “second”, “top”, “bottom”, “upward”, “downward”, “lower”, “front”, “frontward”, “rear”, “rearward”, and “end” are used to simplify the description of the context of the illustrated embodiments. However, other orientations are possible, and the present invention should not be limited to the illustrated orientation(s). Those skilled in the art will appreciate that other orientations of the various components are possible.

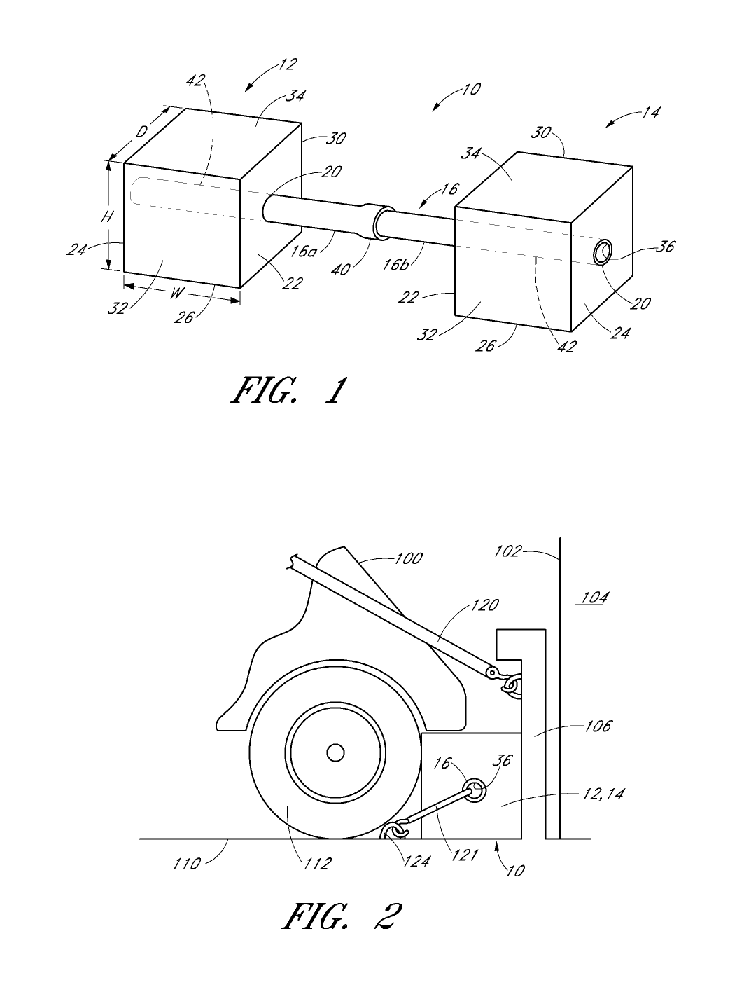

FIG. 1 illustrates a vehicle chock assembly 10 having certain features, aspects and advantages of the invention. The illustrated chock assembly 10 includes a first or left wheel chock 12 and a second or right wheel chock 14. The chocks 12, 14 are interconnected by a connecting rod 16. Preferably, the first chock 12 and the second chock 14 can be positioned next to one another or can be separated from one another or positioned in a spaced-apart orientation on the connecting rod 16 such that the chocks 12, 14 can be positioned to align with left and right wheels of a vehicle that is to be spaced from a surface defining a height. Preferably, only two chocks 12, 14 are provided; however, in other arrangements, additional chocks 12, 14 could be positioned on the connecting rod 16, such as three, four or more chocks 12, 14, for example. In one embodiment, a distance between the chocks 12, 14 can be between zero inches up to about 55 inches, or more. As described, preferably, the chocks 12, 14 can be adjusted to any position within the available range. If necessary or desirable for a given application, the connecting rod 16 can be cut down in length. Alternatively, the connecting rod 16 can be adjustable in length (e.g., of a telescoping arrangement).

The chocks 12, 14 can be coupled to the connecting rod 16 by any suitable manner; however, in the illustrated arrangement, the chocks 12, 14 each include a passage 20 that extends from one side surface, preferably an inner or inward-facing side surface 22, toward a second side surface, preferably an outer or outward-facing side surface 24. Preferably, the passages 20 extend completely through the chocks 12, 14 such that an opening is defined at each end of the passage 20. However, in other arrangements, the passages 20 may pass only partially through the chocks 12, 14. Opposing ends of the connecting rod 16 are received within the passages 20 of the first and second chocks 12, 14. Preferably, the shape of the passages 20 substantially match or are complementary to the shape of the opposing ends of the connecting rod 16 and have a relatively snug or interference fit with one another such that the chocks 12, 14 preferably can be assembled to the connecting rod 16 by hand and adjusted relative to the connecting rod 16. However, preferably, the fit between the passages 20 of the chocks 12, 14 and the connecting rod 16 is snug enough to create a sufficient resistance to movement such that, once positioned, the chocks 12, 14 tend to stay where positioned during normal use unless or until the chocks 12, 14 are deliberately adjusted relative to the connecting rod 16. Preferably, the passages 20 are located within a central portion of the chocks 12, 14 and, in particular, at or near a center (e.g., geometric center) of the side surfaces 22, 24 of the chocks 12, 14. However, in other arrangements, the passages 20 can be located elsewhere, but preferably are located such that the passages are completely surrounded, except for the side opening(s), by a body of the chocks 12, 14.

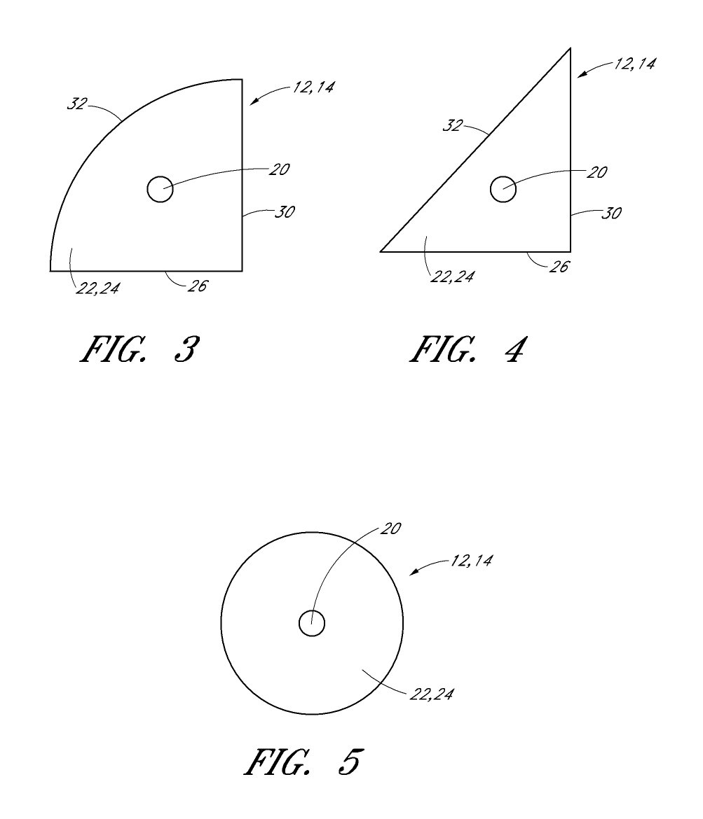

Preferably, each of the chocks 12, 14 defines at least a bottom surface 26 having a forward edge and a rearward edge, a rearward surface 30 having a bottom edge and a top edge, and a forward surface 32 having a bottom edge and a top edge. In the illustrated arrangement, the chocks 12, 14 are hexahedron or substantially hexahedron in shape. The chocks 12, 14 can be cubic or define a cube shape, in which each of the sides is equal in size and shape, or the chocks 12, 14 can have sizes that vary in size. Thus, the illustrated chocks 12, 14 also include a top surface 34 having a forward edge and a rearward edge. In addition, the side surfaces 22, 24 can be parallel to one another. However, the chocks 12, 14 can be of any other suitable shape that is capable of spacing the wheel or other portion (e.g., bumper or brush guard) of a vehicle from a surface having a height. In other embodiments, one or more surfaces of the chocks can be shaped to specifically match a vehicle which is spaced by the chock assembly 10 and/or the surface from which the chock assembly 10 spaces the vehicle. Several alternative shapes are shown and described with reference to FIGS. 3-5.

The chocks 12, 14 can be constructed from any suitable material by any suitable process. Preferably, the chocks 12, 14 have sufficient structural rigidity to resist significant deformation in response to forces typically applied by tie-downs, rope or other strapping used to secure a vehicle relative to a surface with the chock assembly 10 interposed between the vehicle and the surface. In some embodiments, the chocks 12, 14 are constructed from a foam or foam-like material. In particular, the material can be any structural or closed-cell foam. For example, polypropylene or polyurethane can be used.

The chocks 12, 14 define a width W, a height H and a depth D. The width W can be selected to provide a sufficient amount of support to a wheel of a vehicle that is used with the chock assembly 10. For example, the width W can be approximately the same dimension or larger than a width of the wheel of the vehicle. In one arrangement, the width can be between about 6-10 inches. However, other widths are also possible. The height H can be selected to accommodate the wheel (or range of wheels) or other features of the vehicle with which the chock assembly 10 is intended for use. For example, the height H of the chock 12, 14 can be scaled relative to the height of the wheel or other feature of the vehicle. The height H can be at least one-half the height of the wheel or at least the height of the wheel. In some cases, it is desirable for the height H to be less than the height of the wheel. In one arrangement, the height H can be between about 6-18 inches. However, other heights H are also possible. The depth D can be selected to provide enough spacing between the vehicle and the surface from which the vehicle is spaced to accommodate protruding portions of the vehicle. For example, the depth D can be selected based on a dimension between a forward-most point on the wheel and a forward-most point on the vehicle. In one arrangement, the depth D can be between about 6-14 inches. As described above, the height H and depth D of any particular chock 12, 14 can be the same (square) or different (rectangular). In some cases, having the height H and depth D different can improve the adaptability of the chock assembly 10 because the amount of spacing of the vehicle can be altered by rotating the chock assembly 10 about an axis defined by the connecting rod 16 to change which surface 26, 30, 32, 34 is the forward, bottom, rearward and top surface (relative to the instantaneous orientation of the chock assembly 10).

The connecting rod 16 can be of any suitable shape or construction. The illustrated connecting rod 16 is generally cylindrical in shape and defines a circular cross-sectional shape. Preferably, the connecting rod 16 is hollow such that it defines a passage 36 extending completely therethrough. The passage 36 can permit a rope, strap or other similar object to be passed through the passage 36 and used to secure the chock assembly 10 to an object. In one arrangement, the connecting rod 16 can be constructed of a pipe, such as a PVC or metal pipe. As described above, the connecting rod 16 defines a first linear end 40 and a second linear end 42, each of which supports a respective one of the first and second chocks 12, 14. In the illustrated arrangement, the central portion of the connecting rod 16 between the ends 40, 42 can be linear in shape, or can have any other suitable shape.

Preferably, the connecting rod 16 includes two portions 16a, 16b that can be selectively adjusted relative to one another and/or, preferably, can be uncoupled and coupled to one another. A coupling 44 allows the two portions 16a, 16b to be interconnected for use and disconnected for initial (prior to customer purchase) or subsequent packaging, shipping or transport. The coupling 44 can be of any suitable construction. However, in the illustrated arrangement, the coupling 44 is an overlapping, friction-fit joint. For example, the coupling 44 can be formed by the connecting rod portions 16a, 16b, themselves. In particular, one of the connecting rod portions 16a, 16b can define a flared end such that an end of the other of the connecting rod portions 16a, 16b can be snugly received within the flared end and held by a friction fit against inadvertent or undesired disconnection. However, in other arrangements, a separate component can be used in the formation of the coupling 44, such as a coupling (e.g., tube-to-tube connector) that can receive and connect respective ends of the connecting rod portions 16a, 16b. Although a friction-fit coupling provides acceptable performance and is preferred for its simplicity; however, in some arrangements, an additional mechanism can be used to secure or lock the connecting rod portions 16a, 16b together, such as a set screw held by one portion 16a, 16b and contacting the other portion 16a, 16b, for example.

FIG. 2 illustrates the chock assembly 10 used to space a vehicle 100 from a surface 102 having a height. In the illustrated arrangement, the vehicle 100 is an all-terrain vehicle (ATV). However, the chock assembly 10 can be used with a wide variety of vehicles, having a wheel (e.g., trike or 3-wheeler) or a pair of wheels spaced apart from one another along an axis of rotation. For example, the vehicle 100 could be a side-by-side utility vehicle, a lawn mower, a golf cart, a go-cart or other vehicles. In the illustrated arrangement, the surface 102 is the rear surface of a cab portion of a truck 104, which can (and often does) include a window. The surface could also be defined by the forward end wall 106 of a bed 110 of the truck 104. The illustrated chock assembly 10 is especially well-suited for use in the context of spacing a vehicle 100 from a rear cab surface 102 of a truck 104. However, the chock assembly 10 can also be used in a wide variety of applications, including spacing a vehicle 100 from a surface or wall defined by a trailer (open or enclosed), a wall or any other surface that defines a height relative to another surface (e.g., the surface on which the vehicle rests).

In operation, the chock assembly 10 can be placed within a forward portion of the truck bed 110 near or against the end wall 106. Optionally, in certain embodiments, the first chock 12 and first portion 16a of the connecting rod 16 can be assembled to the second chock 14 and second portion 16b of the connecting rod 16. The distance between the chocks 12, 14 can be adjusted to conform to a width of the truck bed 110 or the distance between the wheels 112 of the vehicle 100 that are to be positioned closest to the end wall 106, or both. The wheels 112 could be the front or the rear wheels of the vehicle 100. The vehicle 100 can be loaded into the truck bed 110 and positioned against the chocks 12, 14, which serve to space the vehicle 100 or certain parts thereof (e.g., bumper, brush guards) from the end wall 106 and/or rear cab surface 102. In some arrangements, if the height H dimension of the chocks 12, 14 differs from the depth D dimension of the chocks 12, 14, the chock assembly 10 can be rotated to alter the distance that the vehicle 100 is spaced from the end wall 106 and/or rear cab surface 102 or to avoid interference with or better accommodate a portion of the vehicle 100. The chock assembly 10 can provide some shock absorption characteristics if the vehicle 100 is moved toward the end wall 106 with excessive speed and/or force. Thus, the preferred foam or foam-like materials for the chocks 12, 14 can advantageously dissipate some of the energy of the vehicle 100 from being transferred to the truck 104.

The vehicle 100 can be secured relative to the truck bed 110 by any suitable retention mechanism, such as a strap, rope or tie-down assembly 120, which can be secured to the vehicle 100 and to a tie-off, hook or other mount 122 of the truck 104. Other suitable retention mechanisms can also be used. In embodiments in which the connecting rod 16 is hollow and defines the passage 36, a strap 121, rope, tie-down or other similar device can be passed from one side of the chock assembly 10, through the passage 36, to the other side of the chock assembly 10 and be secured to a tie-off, hook or other mount 124 of the truck 104. Accordingly, the chock assembly 10 can be secured within the truck bed 110 with or without the vehicle 100 in place. The presence, type and/or location of the mounts 122, 124 can vary from vehicle to vehicle. In addition, although described in the context of a vehicle 100 in a truck bed 110, the method of using the chock assembly 10 in other contexts can be the same or similar to the method described above.

FIGS. 3-5 illustrate examples of alternative shapes of the side surfaces 22, 24 (height H and depth D dimensions) of the chocks 12, 14. FIG. 3 illustrates a chock 12, 14 with a curved forward/top surface 32 extending from the bottom surface 26 to the rearward surface 30. FIG. 4 illustrates a chock 12, 14 with a flat forward/top surface 32 extending from the bottom surface 26 to the rearward surface 30, thus creating a triangular side shape. FIG. 5 illustrates a chock 12, 14 having a circular side shape, which has no distinct bottom, forward, top or rearward surfaces and no distinct edges between surfaces. However, a circular chock 12, 14 has bottom, forward, top or rearward surface portions (26, 32, 34, 30) that allow the chock 12, 14 to function in a manner similar to the above-described chocks 12, 14. The illustrated examples of suitable or advantageous shapes herein are not exhaustive. Other suitable shapes can also be used.

Although the invention presented herein has been disclosed in the context of certain preferred embodiments and examples, it will be understood by those skilled in the art that the invention extends beyond the specifically disclosed embodiments to other alternative embodiments and/or uses of the invention and obvious modifications and equivalents thereof. Thus, it is intended that the scope of the invention herein disclosed should not be limited by the particular embodiments described above, but should be determined only by a fair reading of the claims that follow.

What is claimed is:

1. A vehicle chock assembly for spacing a vehicle from a surface, the surface having a height and positioned forward of the vehicle, the chock assembly comprising:
a first chock having a bottom surface, a rearward surface, a forward surface and two opposing side surfaces, the bottom surface having a forward edge and a rearward edge, the rearward surface having a bottom edge and a top edge, the rearward surface extending upward from the rearward edge of the bottom surface and oriented substantially at a right angle relative to the bottom surface, the forward surface having a bottom edge and a top edge, the forward surface extending upward from the forward edge of the bottom surface, a passage extending from one of the side surfaces toward the other side surface;
a second chock having a bottom surface, a rearward surface, a forward surface and two opposing side surfaces, the bottom surface having a forward edge and a rearward edge, the rearward surface having a bottom edge and a top edge, the rearward surface extending upward from the rearward edge of the bottom surface and oriented substantially at a right angle relative to the bottom surface, the forward surface having a bottom edge and a top edge, the forward surface extending upward from the forward edge of the bottom surface, a passage extending from one of the side surfaces toward the other side surface;
a connecting rod configured to connect the first chock and the second chock in a spaced relationship, the connecting rod having a first linear end and a second linear end, wherein the first linear end is received within the passage of the first chock and the second linear end is received within the passage of the second chock.

2. The chock assembly of claim 1, wherein the connecting rod has a first portion and a second portion that are capable of being separated from one another, a coupling arrangement that couples the first portion and the second portion of the connecting rod.

3. The chock assembly of claim 2, wherein the coupling arrangement comprises an overlapping, friction-fit joint.

4. The chock assembly of claim 1, wherein the connecting rod is hollow and defines a passage extending in a lengthwise direction completely through the connecting rod.

5. The chock assembly of claim 1, wherein each of the first and second chocks further comprises a top surface having a forward edge and a rearward edge, wherein the top surface extends from the top edge of the forward surface to the top edge of the rearward surface.

6. The chock assembly of claim 5, wherein the first chock and the second chock each define a substantially hexahedron shape.

7. The chock assembly of claim 1, wherein the opposing side surfaces of each of the first and second chocks are parallel with one another.

8. The chock assembly of claim 1, wherein the passages of each of the first and second chocks extend completely through the opposing side surfaces of the chocks.

9. A combination, comprising:
a vehicle having a pair of wheels spaced apart from one another along an axis of rotation;
a surface from which the vehicle is spaced, the surface defining a height;
a chock assembly, comprising:
a first chock having a bottom surface, a rearward surface, a forward surface and two opposing side surfaces, the bottom surface having a forward edge and a rearward edge, the rearward surface having a bottom edge and a top edge, the rearward surface extending upward from the rearward edge of the bottom surface, the forward surface having a bottom edge and a top edge, the forward surface extending upward from the forward edge of the bottom surface, a passage extending from one of the side surfaces toward the other side surface;
a second chock having a bottom surface, a rearward surface, a forward surface and two opposing side surfaces, the bottom surface having a forward edge and a rearward edge, the rearward surface having a bottom edge and a top edge, the rearward surface extending upward from the rearward edge of the bottom surface, the forward surface having a bottom edge and a top edge, the forward surface extending upward from the forward edge of the bottom surface, a passage extending from one of the side surfaces toward the other side surface;
a connecting rod configured to connect the first chock and the second chock in a spaced relationship, the connecting rod having a first linear end and a second linear end, wherein the first linear end is received within the passage of the first chock and the second linear end is received within the passage of the second chock;
wherein the chock assembly is positioned between the vehicle and the surface such that at least portions of the rearward surfaces of the first and second chocks contact the surface and one of the pair of wheels contacts the forward surface of the first chock and the other of the pair of wheels contacts the forward surface of the second chock.

10. The combination of claim 9, wherein the surface is defined by one of a truck bed, a trailer, and a wall.

11. The combination of claim 9, wherein the vehicle is one of an all-terrain vehicle, a side-by-side utility vehicle, a lawn mower, a golf cart, and a go-cart.

12. The combination of claim 9, wherein the connecting rod has a first portion and a second portion that are capable of being separated from one another, a coupling arrangement that couples the first portion and the second portion of the connecting rod.

13. The combination of claim 12, wherein the coupling arrangement comprises an overlapping, friction-fit joint.

14. The combination of claim 9, wherein the connecting rod is hollow and defines a passage extending in a lengthwise direction completely through the connecting rod.

15. The combination of claim 14, further comprising a rope or strap extending through the passage of the connecting rod and secured to an object to hold the chock assembly against the surface.

16. The combination of claim 9, wherein the first chock and second chock are movable relative to a respective on of the first linear end and the second linear end of the connecting rod such that a distance between the first chock and the second chock can be adjusted.

17. The combination of claim 16, wherein the passages of each of the first and second chocks extend completely through the opposing side surfaces of the chocks.

18. A method of spacing a vehicle from a surface defining a height, comprising:
positioning a chock assembly between the vehicle and the surface;
adjusting a position of one or both of a first chock and a second chock of the chock assembly relative to a connecting rod that extends in between and interconnects the first chock and the second chock such that the first chock is aligned with a first wheel of the vehicle and the second chock is aligned with a second wheel of the vehicle;
securing the vehicle relative to the surface such that the first chock and the second chock contact the surface, and the first wheel contacts the first chock and the second wheel contacts the second chock.

19. The method of claim 18, further comprising passing a rope or strap through a central passage in the connecting rod and using the rope or strap to secure the chock assembly relative to the surface.

20. The method of claim 18, wherein the connecting rod comprises a first portion supporting the first chock and a second portion supporting the second chock, the method further comprising coupling the first portion to the second portion.
